(19) United States
(12) Patent Application Publication
(10) Pub. No.: US 2024/0054092 A1
(43) Pub. Date: Feb. 15, 2024

(54) SYSTEM FOR INTERFACING MEDIA DEVICES

(71) Applicant: ARRIS ENTERPRISES LLC, Suwanee, GA (US)

(72) Inventor: Iain Duncan RAYNER, Bradford (GB)

(21) Appl. No.: 18/266,380

(22) PCT Filed: Oct. 28, 2021
(86) PCT No.: PCT/US21/57006

§ 371 Date: Jun. 9, 2023

Related U.S. Application Data
(60) Provisional application No. 63/124,683, filed on Dec. 11, 2020.

(51) Int. Cl. G06F 13/40; G06F 13/42

(52) U.S. Cl. CPC G06F 13/409; G06F 13/4282

(57) ABSTRACT

A system for interfacing media devices utilizing an improved connector that provides electromagnetic interference isolation for high-speed data communications and efficient utilization of the limited electrical conductors upon connector. The connector provides physical isolation of conductor interfaces from circuitry supporting high-speed data streaming. Furthermore, the disclosed connector technology provides a conductor arrangement suitable for use with system utilizing the time-multiplexing of high-speed data buses.

### BACKGROUND OF THE INVENTION

The delivery of media services to residential environments, via cable, optical or satellite networks, continues to expand. As the number of households availing themselves of these services grows, it can place an increased burden upon the service providers human resources, and in particular upon the technicians available to be dispatched for residential locations to perform premises equipment installation and service. Consequently, it has been advantageous for service providers to supply their subscribing customers with premises equipment, such as home media systems (“HMSs”), that can be installed with little or no assistance form service provider technicians. This do-it-yourself installation is primarily a matter of designing and providing equipment that has a minimal number of ports, connectors, buttons and selectors that a given subscriber would need to concern themselves with during installation, and ensuring that the equipment autonomously performs as many of the processes required for installation as possible.

The provision of premises equipment capable of performing autonomous or semi-autonomous installation processes can become problematic if the installation environment is not homogenous. If the network and/or the pre-existing premises equipment constituting the installation environment varies from one residential site to another, it can become very difficult to address such variations in a cost-effective manner with a single, premises equipment design and still avoid the need for a technician's assistance, with some of the most troublesome being the consequence of efforts by a service provider to upgrade or modernize a network. As a given upgrade is rolled out across a service environment, it will be almost unavoidable to have some residences with one type of hardware (the older premises equipment) and others with a different type (the upgraded hardware).

Consequently, it would be advantageous to provide for an equipment interface that could adaptively mate with a variety of premises equipment types or versions. The interface would provide and accept data streams conforming to the particular protocol(s) utilized by the particular premises equipment with which it was mated. For example, data protocols such as Universal Serial Bus (“USB”) 2.0, USB 3.0, and Serial AT Attachment (“SATA”). Ideally, this adaptation would be performed independent of any user action or intervention outside of connecting the adaptive interface upon the new equipment to the pre-existing installation environment.

One of the most ubiquitous residential premises equipment types in use today is the set-top box. These appliances typically serve as the primary nexus and interface for the provision of media services and content delivered by cable, optical or satellite systems. It is not unusual for these appliances to include digital video recording (“DVR”) functionality which enables consumers to record and store media content locally. This media storage is typically supported by a hard-disk drive (“HDD”) or solid-state drive (“SSD”) associated with the information appliance. While a portion of this storage may be internal to the media appliance, consumers often supplement the storage with external memory (either HDD or SSD). Such external memory usually requires a connection to a dedicated external power supply and is most often linked to the media appliance by a universal serial bus (“USB”) or serial AT attachment (“SATA”) cable. While numerous types of HDD and SSD memory options are available to consumers, it would be advantageous for both the service provider and the consumer to have a simple means of installing and integrating additional, compatible external storage into a residential media appliance environment.

It would therefore be advantageous to provide an adaptive interface capable of mating external storage with an existing information appliance, wherein utilization of the interface would require little or no connecting cables, external power supplies, or specialized tools or knowledge. It would also be beneficial, with respect to both a cost and reliability, to minimize the size and number of connector contacts required to enable the external memory/information appliance mating. Providing a connector that suitably meets the above design consideration has proven difficult, especially given the need to provide adequate electromagnetic shielding of the various conductors given the know interference issues that can arise as a consequence of transmission of SATA and USB 3 data signals. These interference issue can be compounded by emission problems that can arise at points where one connector meets another.

### BRIEF SUMMARY OF THE INVENTION

A system for interfacing media devices utilizing an improved connector that provides electromagnetic interference isolation for high-speed data communications and efficient utilization of the limited electrical conductors upon connector. The connector provides physical isolation of conductor interfaces from circuitry supporting high-speed data streaming. Furthermore, the disclosed connector technology provides a conductor arrangement suitable for use with system utilizing the time-multiplexing of high-speed data buses.

### BRIEF DESCRIPTION OF THE DRAWINGS

The aspects, and advantages of the present invention will become better understood with regard to the following description, appended claims, and accompanying drawings in which:

FIG. 1A provides a bottom and front view of an HMS enclosure and a front and bottom view of an HDD/SSD enclosure in accordance with an embodiment of a media device interface.

FIG. 1B provides a front view of the HMS and HDD/SSD enclosures of FIG. 1A mated with one another.

FIG. 2 is a side perspective-view of male electrical connector utilized within the HDD/SSD enclosure of FIG. 1A.

FIG. 3 is a partial cut-away view of the mated enclosures of FIG. 1B.

FIG. 4 depicts a system embodying an adaptive interface suitable for utilization as a media device interface.

FIG. 5A is a depiction of a prior art first conductor arrangement upon a 42-pin electrical connector.

FIG. 5B is a depiction of a first labeling of an arbitrary conductor arrangement upon the male electrical connector of FIG. 2.

FIG. 5C is a depiction of a second labeling of an arbitrary conductor arrangement upon the male electrical connector of FIG. 2.

### DETAILED DESCRIPTION

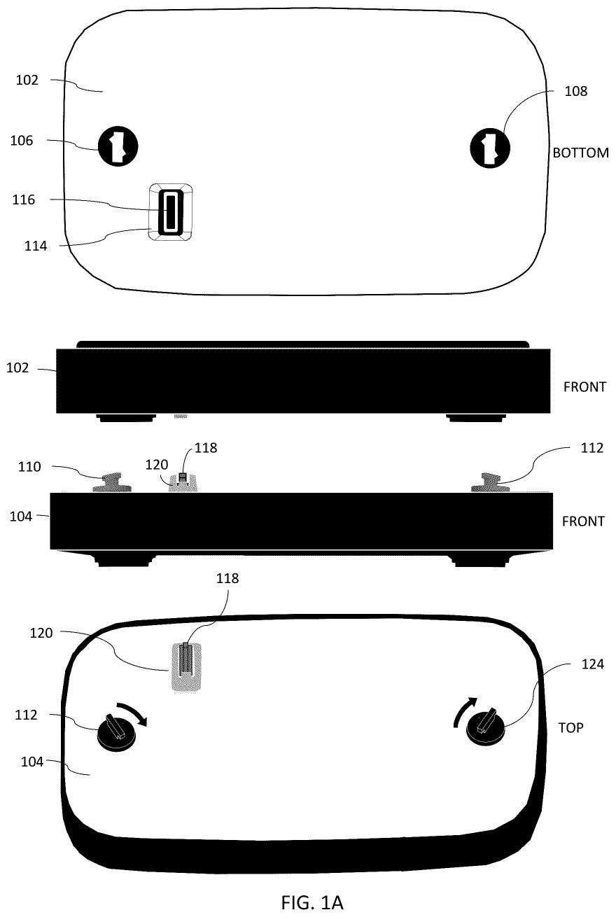

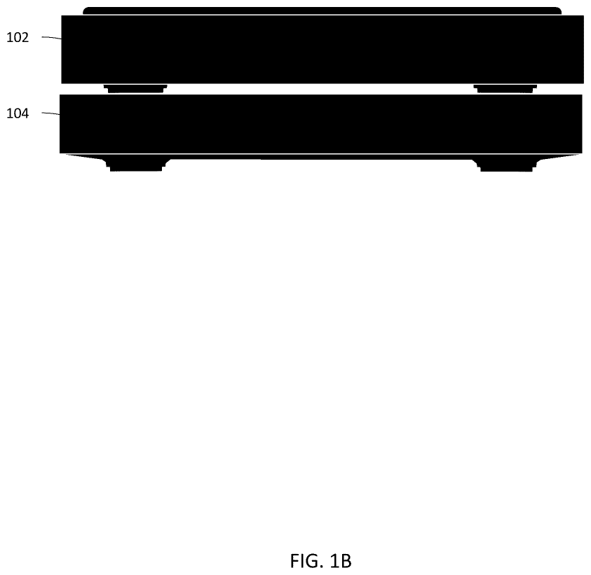

FIG. 1A provides a bottom and front view of an HMS enclosure 102, which is adapted to house the electronics and connectors supporting set-top box, modem, or other information appliance functionality. FIG. 1 also provides a front and top view of HDD/SSD enclosure 104, adapted to house a storage device suitable for mating with information appliance enclosure 102. The bottom view of HMS enclosure 102 shows two latch receptacles. 106 and 108, each positioned to align with latches 110 and 112, respectively, located on the top of HDD/SSD enclosure 104. The bottom of enclosure 302 also includes rectangular recess 114, which permits access to female electrical connector (“FEC”) 116. This receptacle is a 24-conductor connector adapted to mate with male electrical connector (“MEC”) 118, located upon the top of HDD/SSD enclosure 104.

FIG. 1A also provides a top, front and bottom view of HDD/SSD enclosure 104. As shown, enclosure 104 includes two latches (110, 112) extending from the top surface. The top surface also includes a substantially rectangular cowling (120) through which MEC 118 extends. This connector would ideally include both data and power connections for the HDD/SSD memory contained within HMS enclosure 102. The bottom view of HDD/SSD enclosure 104 shows two circular knobs, 122 and 124, each affixed to one of the latches (110 and 112, respectively). When HMS enclosure 102 is appropriately positioned above HDD/SSD enclosure 104, and latches 110 and 112 are properly aligned with the substantially rectangular openings of latch receptacles 106 and 108, respectively, the two enclosures can be brought into contact with another. This will result in the insertion of the mating of MEC 118 with FEC 116. FIG. 1B provides a front view of the mated enclosures.

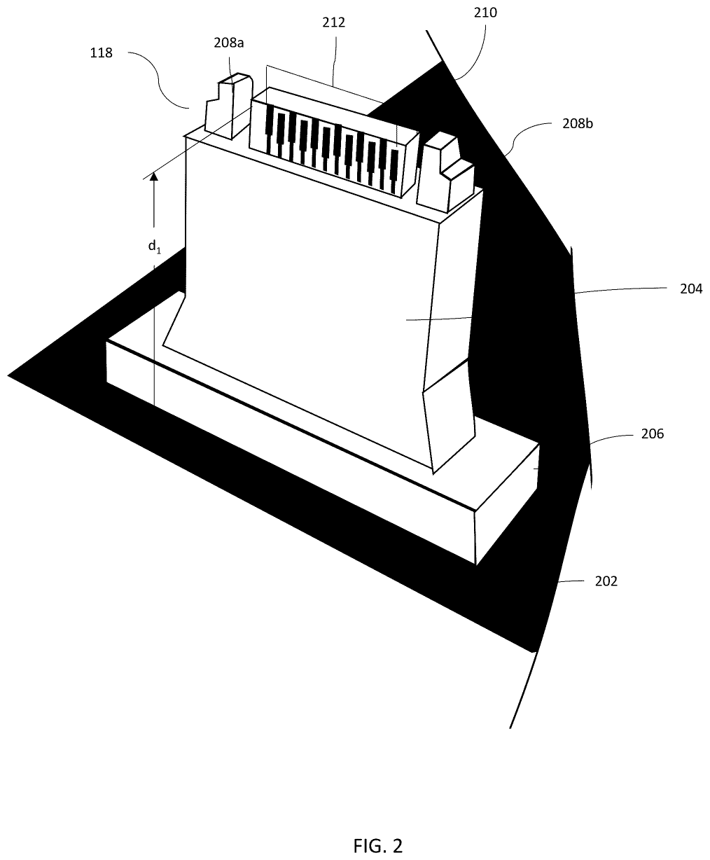

FIG. 2 provides a side perspective-view of MEC 118. As shown, MEC 118 is mounted atop printed circuit board (“PCB”) 202. MEC 118 is ideally comprised of an electrically-insulating material exhibiting a high dielectric constant and providing a reasonable amount of mechanical stability. As shown, MEC 118 includes upright element 204 extending from base element 206, which is attached to PCB 202. In this particular embodiment, width and breadth of base element 206 (which extends beyond the horizontal cross-section of upright element 204) provides added mechanical stability. The top portion of MEC 118 is shown to include alignment pins 208a and 208b, as well as connection assembly 210. Twelve individual electrical contacts (collectively 212) are shown to be affixed to the front of connection assembly 210. Another twelve individual electrical contacts are found on the opposite face of connection assembly 210. Each of these 24 electrical contacts is connected to a corresponding contact on the lower face of base element 206 and each are adapted to make an electrical connection with one or more contact pads upon the face of PCB 202. In addition, each of the 24 electrical contacts are adapted to contact and thereby create an electrical connection with a corresponding electrical contact positioned within FEC 116.

The particular configuration of base element 202 and upright element 204 can be a matter of design choice with respect to most mechanical aspects. However, the distance d₁ that the combined height of elements 202 and 204 comprise is critical. This distance must be set to provide an adequate vertical spacing between the 24 electrical connectors and the upper surface of PCB 202. As was previously stated, it is well known that interference issues that can arise as a consequence of transmission of SATA and USB 3 data signals, and such interference is can be exacerbated at points where one connector meets another. By distancing the point at which MEC 118 will connect with FEC 116 from PCB 202, the consequences of such interference can be minimized. Given that PCB 202 is likely to host a number of high-speed/high-density data transmission circuits, a that SATA and/or USB 3 communications w ill be supported via MEC 118 and FEC 116. In a typical HMS processing SATA and USB 3 data streams, reasonable value for d₁ would be between 18 and 26 mm, however this distance will be dependent upon the data rate and signal strength of the signals upon PCB 204, as well as those of the signals being sent through MEC 118 and FEC 114.

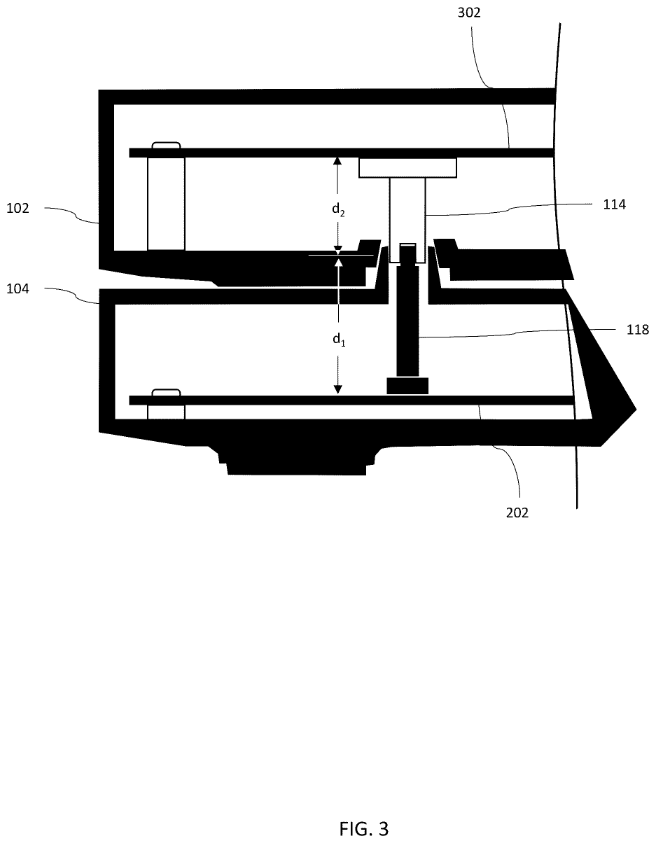

FIG. 3 provides a partial side cut-away view of HMS enclosure 102 mated to HDD/SSD enclosure 104. MEC 118 is shown provide a spacing of distance d₁ between the contact connection points and the surface of PCB 204. Similarly, FEC 114 is shown to provide a spacing distance of d₂ between the contact connection points and the surface of PCB 302. As with d₁, the distance d₂ must be determined as a function of the data rate and signal strength of the signals upon PCB 302, as well as those being sent through MEC 118 and FEC 114.

Both MEC 118 and FEC 114 provide for an arrangement of the 24 contacts upon each of the connectors. The shielding required to effectively protect the various high-density/high-speed data streams (SATA. USB 3, USB 2) that would likely be required to support an HMS, is typically achieved by surrounding each pair of conductors that are transmitting a data stream through a connector with ground connections. This number of contacts is achieved using the same pins for USB 3 and SATA with the detection of the type of signal being performed by the adaptive interface. Without this multi-use feature the MEC 118 and FEC 114 would require as many as 42 contacts.

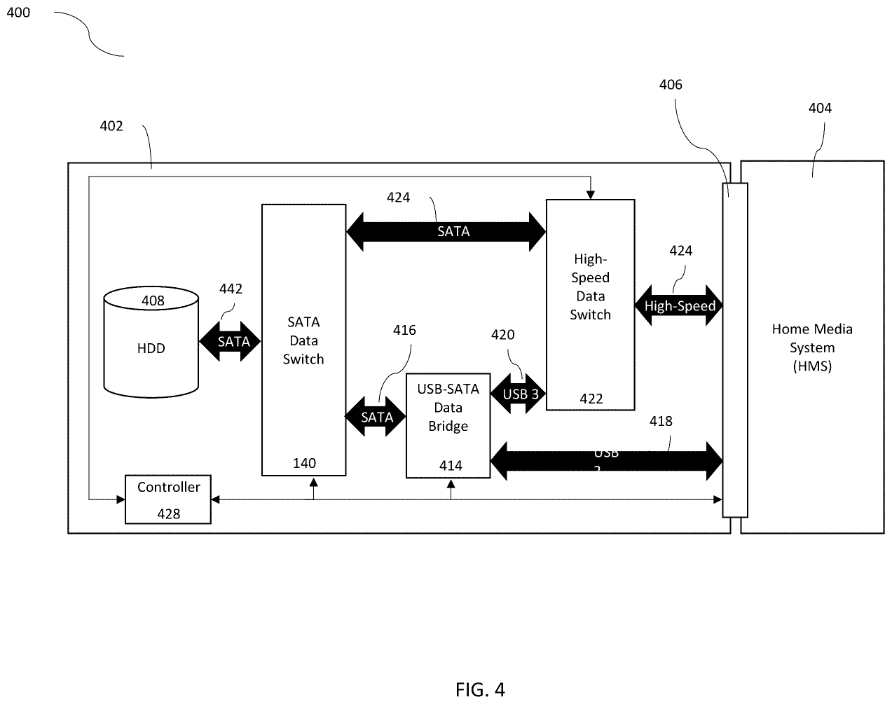

A system embodying one such adaptive interface is depicted in FIG. 4. As shown, storage device 402 is mated with HMS 404 via interface 406. As shown, storage device 402 comprises hard disc drive 408, which is connected to SATA Data Switch 410 by SATA bus 412. SATA Data Switch 410 is linked to USB-SATA bridge 414 by SATA bus 416. USB-SATA bridge 412 converts data between SATA protocol and USB 2 and USB 3 protocols (bus 418 and bus 420, respectively), thereby providing a link between the USB busses (418, 420) and SATA bus 412. High-Speed Data switch 422 serves to route data between High-Speed Data bus 424 (which can support data conforming to either the SATA or USB 3 protocols) and both SATA Data Switch 410 and USB-SATA Data Bridge 414. SATA data is routed via bus SATA data bus 424, and USB 3 data is routed USB 3 bus 420. Controller 428 is adapted to determine if HMS 404 is utilizing SATA or USB 3 data protocol to facilitate data communication with storage device 402. If the controller detects that HMS 404 utilizes USB 3 data protocols, controller 428 configures USB-SATA Bridge 414 to provide a link between USB 3 bus 420 and SATA bus 416. Controller 428 then establishes a data path from HDD 408 to interface 406 via SATA Data Switch 410, USB-SATA Data Bridge 414 and High-Speed Data Switch 422 (step 216). How ever, if controller 428 determines that HMS 404 is utilizing SATA protocol for data communications with storage device 402, controller 426 configures High-Speed Data Switch 422 and SATA Data Switch 410 to establish a path between High-Speed bus 424 and SATA bus 412. This enables data to stream between HDD 406 and HMS 404. This system of FIG. 4 is one example of a high-speed data communication system wherein the same high-speed differential bus (424) is utilized to support both SATA and USB 3 protocol data communications.

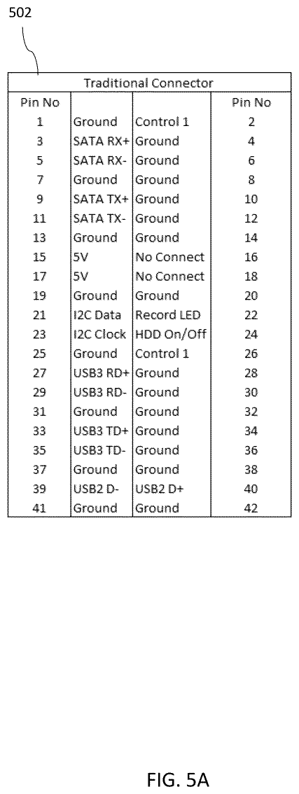

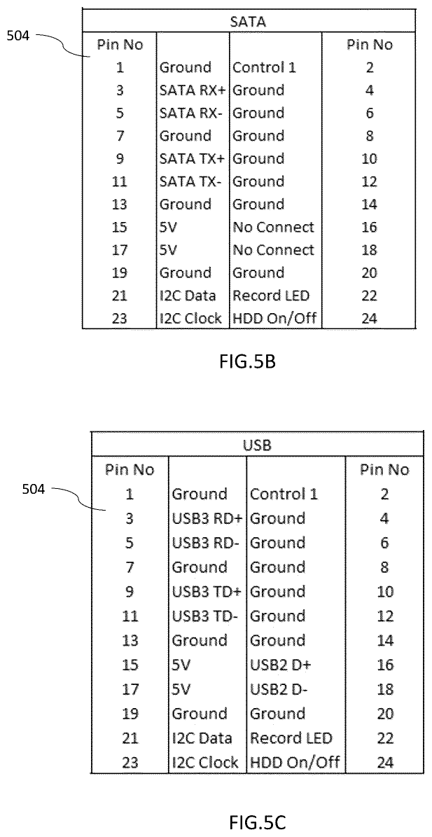

FIG. 5A depicts an arbitrary conductor arrangement (502) upon a 24-conductor electrical connector (such as MEC 118 and FEC 114) that would be suitable for use in conjunction with a system that did not support the time-division multiplexing of SATA and USB 3 data transmissions. As shown, conductors 1-12 and 13, 15, 17 and 19 are required to support the SATA, USB 3 and USB 2 transmissions, leaving just 7 conductors available to support power connections and other critical signals such as clocks, control signals and general input/output lines.

Contrastingly, FIGS. 5B and 5C show and arbitrary conductor arrangement upon the same type of 24-conductor electrical connector in which the USB 3 and SATA differential pairs (collectively referred to as high-speed or HS differential pairs) are supported by the same set of conductors (as would be the case for systems such as the one depicted in FIG. 4). The conductor labeling (504) of FIG. 5B provides the SATA terminal descriptors, and the conductor labeling (506) of FIG. 5C provides the USB 3 terminal descriptors. In this 24-conductor embodiment the same 4 conductors (3, 5, 9 and 10) are utilized for the transmission of both the SATA differential pair signals and the USB 3 differential pair signals (albeit not concurrently). This improved arrangement permits SATA, USB 3 and USB 2 data streams to be effectively transmitted using only 11 conductors (4 for the high-speed differential pairs, 2 for the USB 2 pair, and 5 for the for the shielding ground connectors). As shown, conductors 1, 3, 5, 7, 9, 11, 13, 14, 16, 18 and 20 are required to support the SATA. USB 3 and USB 2 transmissions, leaving 13 conductors available for use in supporting other functionalities. This 24-conductor arrangement also permits greater spacing between the conductors located upon the connector. This can reduce inter-conductor interference that can arise when very dense, high-rate data streams are transmitted via conductors in close proximity to one another.

The disclosed invention offers many advantages, including the ability to automatically prohibit the transmission of video images collected by cameras designated as private without repeated user intervention. It also provides a simple interface enabling users to quickly and easily configure the network camera management system. In addition, the disclosed system is flexible, being limited only by the capacity of the local network associated with the controlling computer/server. Although the invention herein has been described with reference to particular embodiments, it is to be understood that these embodiments are merely illustrative of the principles and applications of the present invention. In addition, various functional aspects of the invention could be implemented via physical arrangements that might have varying degrees of integration. The entirety of the disclosed invention could be implemented within a monolithic system, or disparate discrete components without departing from the spirit and scope of the present invention as defined by the appended claims.

1. A system for interfacing media devices comprising a first connector, wherein the first connector comprises:
a first vertical element having a top surface, a bottom planar surface, a front planar surface, and a back planar surface;
a plurality of electrical contacts situated upon at least one of the front and the back planar surfaces, and positioned so as to distance the plurality of electrical contacts from the bottom planar surface by a distance of d₁; and
a plurality of electrical conductors positioned within the first vertical element, each of which provides an electrical connection between at least one of the plurality of electrical contacts and at least one electrical contact upon the bottom planar surface, wherein at least one of the electrical contacts upon the bottom planar surface is adapted to connect to at least one circuit board comprising conductive paths supporting high-speed data communications;
wherein the distance d₁ is determined based, at least in part, upon one of the following parameters:
the high-speed communications data rate;
the high-speed communications signal strength;
the density of the conductive paths;
the lateral spacing of the electrical contacts situated upon on at least one of the front and the back planar surfaces; and
the horizontal spacing of the electrical contacts upon the bottom planar surface.

2. The system of claim 1 wherein the d₁ is between 18 and 26 mm.

3. The system of claim 1 wherein the high-speed data communications utilize at least one of the following protocols:
Universal Serial Bus 3; and
Serial AT Attachment.

4. The system of claim 1 wherein at least a subset of the electrical contacts upon the bottom planar surface are adapted to connect to at least one circuit board comprising conductive paths supporting data communications conforming to the Universal Bus 2 protocol.

5. The system of claim 1 wherein the plurality of electrical contacts comprises twenty-four electrical contacts.

6. The system of claim 1 wherein a subset of the plurality of electrical contacts situated upon on at least one of the front and the back planar surfaces the first connector are associated with an adaptive interface system, and wherein high-speed conforming to a first protocol is time-multiplexed with high-speed data conforming to a second protocol.

7. The system of claim 6 wherein the subset of the plurality of electrical contacts comprises a differential match pair.

8. The system of claim 1 wherein the connector is further adapted to mate with a complementary receptacle having a plurality of electrical connectors, wherein at least one of the electrical connectors upon the complementary receptacle is positioned to contact at least one of the electrical contacts situated upon on at least one of the front and the back planar surfaces of the first connector.

9. The system of claim 8 wherein the first connector is associated with a home media system and the complementary connector is associated with a storage system.

10. The system of claim 9 wherein the storage system comprises at least one of the following:
a hard-disc drive; and
a solid-state drive.

11. The system of claim 1 further comprising at least one printed circuit board having at least one electrical connection to at least one of the electrical contacts upon the bottom planar surface of the first connector.

12. The system of claim 11 wherein the at least one printed circuit board is substantially encased within an enclosure, and wherein the enclosure comprises an aperture through which a portion of the first connector protrudes, the protruding portion comprising the plurality of electrical contacts situated upon at least one of the front and the back planar surfaces the top portion of the first connector.

13. The system of claim 12 wherein the aperture further comprises a cowling through which the protruding portion extends.

14. The system of claim 1 further comprising the first receptacle adapted to mate with the first connector, wherein the first receptacle comprises:
a socket having a first and a second interior surfaces, wherein at least one of these surfaces comprises a plurality of electrical contacts situated so as to contact at least one of the plurality of electrical contacts situated the font and the back planar surfaces of the first connector when the first connector and the first receptacle are mated.
